(19) United States
(12) Patent Application Publication
(10) Pub. No.: US 2025/0317647 A1
(43) Pub. Date: Oct. 9, 2025

(54) ACCESSORY INFORMATION GENERATION METHOD, IMAGING SYSTEM, AND ACCESSORY INFORMATION GENERATION PROGRAM

(71) Applicant: FUJIFILM Corporation, Tokyo (JP)

(72) Inventors: Tetsuya FUJIKAWA, Saitama-shi (JP); Masahiko Sugimoto, Saitama-shi (JP)

(73) Assignee: FUJIFILM Corporation, Tokyo (JP)

(21) Appl. No.: 19/243,674

(22) Filed: Jun. 19, 2025

Related U.S. Application Data
(63) Continuation of application No. PCT/JP2023/042218, filed on Nov. 24, 2023.

(30) Foreign Application Priority Data
Dec. 26, 2022 (JP) 2022-208410

(51) Int. Cl. H04N 23/60; G11B 27/34

(52) U.S. Cl. CPC H04N 23/64; G11B 27/34

(57) ABSTRACT

Provided is an accessory information generation method in an imaging apparatus that is attachable to an optical device. The accessory information generation method includes: first generating accessory information that includes at least whether or not imaging is performed via the optical device in image data captured by the imaging apparatus.

### CROSS-REFERENCE TO RELATED APPLICATIONS

This is a continuation of International Application No. PCT/JP2023/042218 filed on Nov. 24, 2023, and claims priority from Japanese Patent Application No. 2022-208410 filed on Dec. 26, 2022, the entire content of which is incorporated herein by reference.

### BACKGROUND OF THE INVENTION

### 1. Field of the Invention

The present invention relates to an accessory information generation method, an imaging system, and a computer-readable storage medium storing an accessory information generation program.

### 2. Description of the Related Art

JP2015-200700A discloses an adapter that bonds a portable terminal with a camera function and an optical device having an eyepiece lens, and is used for imaging an image of an object magnified by the optical device with the portable terminal. A portable terminal attachment unit and an optical device attachment unit for attaching the portable terminal and the optical device to a main body such that an optical axis of a camera lens of the portable terminal and an optical axis of an eyepiece lens of the optical device connect in a straight line are provided on the main body back to back. In addition, an opening portion that faces the camera lens on a side of an eyepiece lens of the optical device is formed at a portion of the main body corresponding to the camera lens of the portable terminal.

JP2019-133518A discloses a mobile information terminal and a program for astronomical observation and imaging, which can easily perform astronomical imaging by mounting a camera lens close to an eyepiece inserted into a draw tube of an astronomical telescope, activating an application, selecting an astronomical object to be observed, starting navigation of the astronomical object in a finder mode in which the observation is performed, adjusting an orientation and an inclination of the astronomical telescope with respect to the astronomical object to be observed, and switching to a camera mode in a case where a button of the camera mode for performing imaging is operated.

### SUMMARY OF THE INVENTION

One embodiment according to the technology of the present disclosure provides, for example, an accessory information generation method, an imaging system, and a computer-readable storage medium storing an accessory information generation program that generate accessory information including at least whether or not imaging is performed via an optical device in image data captured by an imaging apparatus.

(1)

An accessory information generation method in an imaging apparatus that is attachable to an optical device, the method comprising: a first generation step of generating accessory information including at least whether or not imaging is performed via the optical device in image data captured by the imaging apparatus.

(2)

The accessory information generation method according to (1), in which the imaging apparatus is attachable to the optical device via an adapter.

(3)

The accessory information generation method according to (2), in which the adapter has a mechanism capable of switching the imaging apparatus attached to the optical device between a first state in which imaging via the optical device is possible and a second state different from the first state.

(4)

The accessory information generation method according to any one of (1) to (3), in which the first generation step includes a step of discriminating whether or not the imaging is performed via the optical device, and a step of generating accessory information including whether or not the imaging is performed via the optical device based on a result of the discrimination.

(5)

The accessory information generation method according to (4), in which the discrimination is performed based on image analysis of the image data.

(6)

The accessory information generation method according to (4) or (5), in which the discrimination is performed based on an imaging distance in the imaging.

(7)

The accessory information generation method according to any one of (4) to (6), in which the discrimination is performed based on a detection result of a proximity sensor provided in the imaging apparatus.

(8)

The accessory information generation method according to any one of (1) to (7), in which the accessory information in a case where the imaging is performed without the optical device includes information indicating, based on an imaging distance in the imaging, whether or not the imaging is close-up imaging.

(9)

The accessory information generation method according to any one of (1) to (8), further comprising: an assignment step of assigning the accessory information to the image data.

(10)

The accessory information generation method according to (9), further comprising: a second generation step of generating, for a plurality of pieces of image data including image data to which the accessory information is assigned by the assignment step, related information between the plurality of pieces of image data, based on the accessory information.

(11)

The accessory information generation method according to (10), in which the accessory information includes first label information indicating whether or not the imaging is performed via the optical device, positional information of the imaging, and azimuthal angle information of the imaging, and in the second generation step, a region of the imaging is calculated based on at least the positional information and the azimuthal angle information, and the related information between the image data is generated based on the region of the imaging.

(12)

The accessory information generation method according to (11), in which the accessory information in a case where the imaging is performed without the optical device includes second label information indicating, based on an imaging distance in the imaging, whether or not the imaging is close-up imaging, and in the second generation step, a region of the imaging is calculated based on at least the first label information, the positional information, the azimuthal angle information, and the second label information.

(13)

The accessory information generation method according to any one of (10) to (12), in which in the second generation step, the related information between the image data is generated based on a category of a subject of the imaging.

(14)

The accessory information generation method according to any one of (10) to (13), in which the related information between the image data is information capable of determining image data obtained by imaging the same subject among the plurality of pieces of image data.

(15)

The accessory information generation method according to (14), in which the related information between the image data includes information for associating the image data obtained by imaging the same subject with the same subject.

(16)

The accessory information generation method according to any one of (1) to (15), in which the optical device is a telescope or a binocle.

(17)

An imaging system comprising: an optical device; and an imaging apparatus that is attachable to the optical device and includes a processor, wherein the processor is configured to generate accessory information including whether or not imaging is performed via the optical device in image data captured by the imaging apparatus.

(18)

A non-transitory computer-readable storage medium storing an accessory information generation program, which is an imaging system including an optical device, and an imaging apparatus that is attachable to the optical device and includes a processor, the program for causing the processor to execute processing of: generating accessory information including at least whether or not imaging is performed via the optical device in image data captured by the imaging apparatus.

### BRIEF DESCRIPTION OF THE DRAWINGS

FIG. 1 is a front perspective view showing an example of an imaging system.

FIG. 2 is a rear perspective view showing an example of the imaging system.

FIG. 3 is a front perspective view showing an example of an adapter.

FIG. 4 is a rear perspective view showing an example of the adapter.

FIG. 5 is a rear perspective view showing an example of a state in which a holding portion is rotated to a first position and a second position in the adapter.

FIG. 6 is a front perspective view showing an example of a first observation mode (first state) of the imaging system.

FIG. 7 is a rear perspective view showing an example of a first observation mode of the imaging system.

FIG. 8 is a front perspective view showing an example of a second observation mode (second state) of the imaging system.

FIG. 9 is a rear perspective view showing an example of a second observation mode of the imaging system.

FIG. 10 is a left side view showing an example of a usage state of the imaging system in a first observation mode.

FIG. 11 is a left side view showing an example of a usage state of the imaging system in a second observation mode.

FIG. 12 is a network configuration diagram of a cloud image management system including a smartphone.

FIG. 13 is a diagram showing an example of a hardware configuration of a smartphone.

FIG. 14 is a flowchart showing a procedure of processing of executing an accessory information generation method of assigning accessory information to imaging data captured by a smartphone.

FIG. 15 is a flowchart showing a procedure of processing of determining a relevance between a plurality of pieces of imaging data.

FIG. 16 is a conceptual diagram showing states of various types of imaging.

### DESCRIPTION OF THE PREFERRED EMBODIMENTS

In the following, an example of an embodiment of a data generation method, an imaging system, and a data generation program according to the technology of the present disclosure will be described with reference to the accompanying drawings.

First, an imaging system to which the technology of the present disclosure is applied will be described.

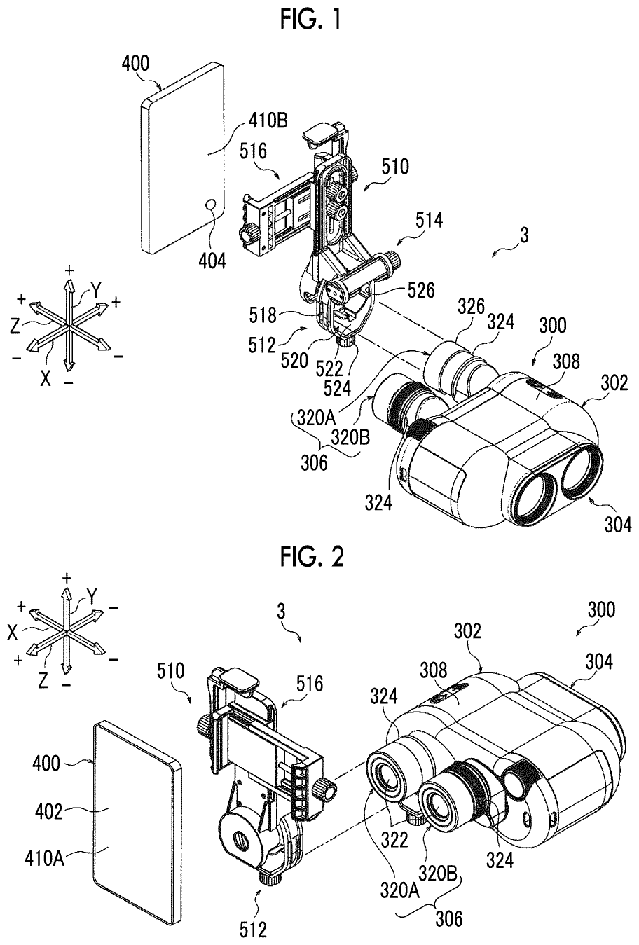

As an example, as shown in FIGS. 1 and 2, the imaging system 3 comprises a binocle 300, a smartphone 400, and an adapter 510. The imaging system 3 corresponds to a set of a binocle 300, a smartphone 400, and an adapter 510. The adapter 510 is a connection device that connects the smartphone 400 to the binocle 300. The imaging system 3 is an example of an “imaging system” according to the technology of the present disclosure. The binocle 300 is an example of an “optical device” according to the technology of the present disclosure. The smartphone 400 is an example of an “imaging apparatus” according to the technology of the present disclosure. The adapter 510 is an example of an “adapter” according to the technology of the present disclosure.

The binocle 300 is, for example, an optical anti-vibration binocle having an anti-vibration function. Here, although an optical anti-vibration binocle is exemplified as an example of the binocle 300, this is merely an example, and the binocle 300 may be any binocle having any function. In the binocle 300, for example, a width direction, a height direction, and a length direction are defined. The width direction, the height direction, and the length direction of the binocle 300 are directions orthogonal to each other. The X direction indicates a width direction of the binocle 300, the Y direction indicates a height direction of the binocle 300, and the Z direction indicates a length direction of the binocle 300.

Hereinafter, a width direction of the binocle 300 will be referred to as an X direction, a height direction of the binocle 300 will be referred to as a Y direction, and a length direction of the binocle 300 will be referred to as a Z direction. In addition, one side of the binocle 300 in the width direction is referred to as an X− side, and the other side of the binocle 300 in the width direction is referred to as an X+ side. In addition, one side of the binocle 300 in the height direction is referred to as a Y+ side, and the other side of the binocle 300 in the height direction is referred to as a Y− side. In addition, one side of the binocle 300 in the length direction is referred to as a Z+ side, and the other side of the binocle 300 in the length direction is referred to as a Z− side.

The binocle 300 comprises a main body 302, an objective optical portion 304, and an ocular optical portion 306. The objective optical portion 304 and the ocular optical portion 306 are arranged in the Z direction via the main body 302. The objective optical portion 304 is provided on the Z− side with respect to the main body 302, and the ocular optical portion 306 is provided on the Z+ side with respect to the main body 302. A Z− side of the binocle 300 corresponds to a distal end side of the binocle 300, and a Z+ side of the binocle 300 corresponds to a rear end side of the binocle 300. The binocle 300 is a binocle having an objective optical portion 304 on a distal end side and an ocular optical portion 306 on a rear end side.

The main body 302 is a portion positioned between the objective optical portion 304 and the ocular optical portion 306 in the binocle 300, and constitutes a main body portion of the binocle 300. The main body 302 has a housing 308. For example, an anti-vibration structure (not shown) that realizes an anti-vibration function is housed inside the housing 308.

The smartphone 400 is formed in a rectangular flat shape in front view. The smartphone 400 comprises a touch panel display 402 and a camera 404. The touch panel display 402 is provided on an entire front surface 410A of the smartphone 400, and the camera 404 is provided at an upper corner portion of a rear surface 410B of the smartphone 400. The rear surface 410B is a surface opposite to the front surface 410A. The camera 404 may be provided flush with the rear surface 410B or may protrude from the rear surface 410B. In addition, the camera 404 may be provided at a position recessed with respect to the rear surface 410B.

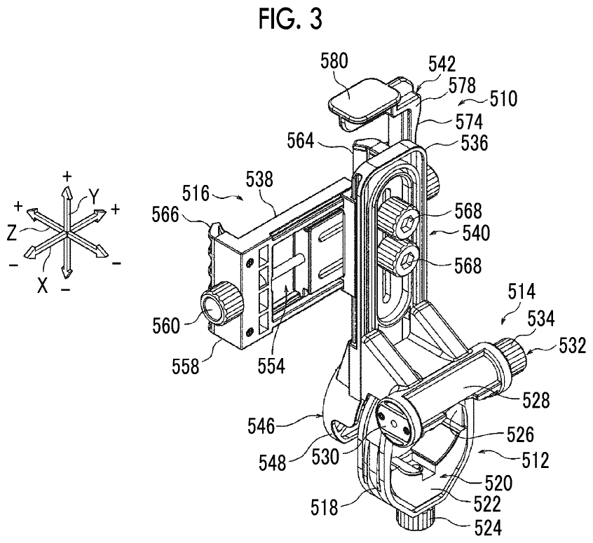

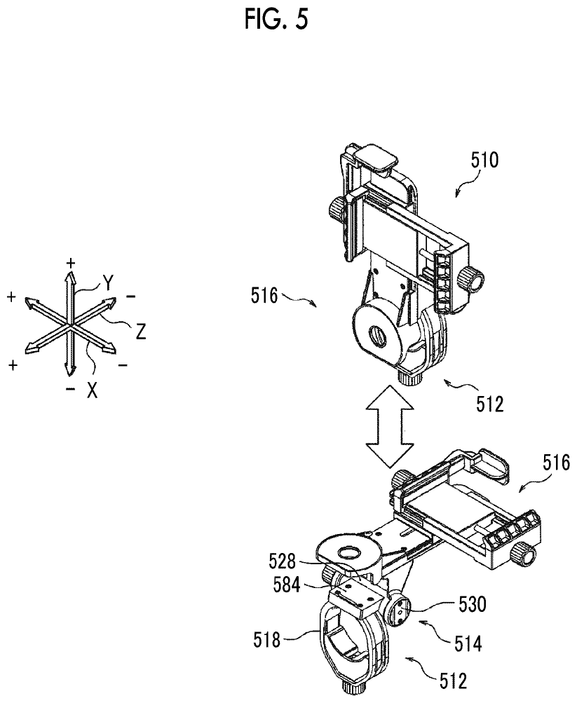

As shown in FIGS. 3 to 5 as an example, the adapter 510 comprises a fixed portion 512, a support portion 514, and a holding portion 516. As shown in FIG. 5, the holding portion 516 is rotatably supported at a first position shown on the upper side of FIG. 5 and a second position shown on the upper side of FIG. 5 by the support portion 514. The first position is a position in a case where the holding portion 516 is rotated to a first end part on the Y+ side in the movable range (that is, a rotation range), and the second position is a position in a case where the holding portion 516 is rotated to a second end part on the Z− side in the movable range. A stopper portion 584 is formed at an end part of the fixing member 518 on the Y+ side. The first end part in the movable range of the holding portion 516 is defined, for example, by the holding portion 516 interfering with the stopper portion 584. In addition, the second end part in the movable range of the holding portion 516 is defined, for example, by providing a stopper structure (for example, a facing surface of the stopper portion 584 on the Z− side) between the rotation support portion 528 and the rotating portion 530.

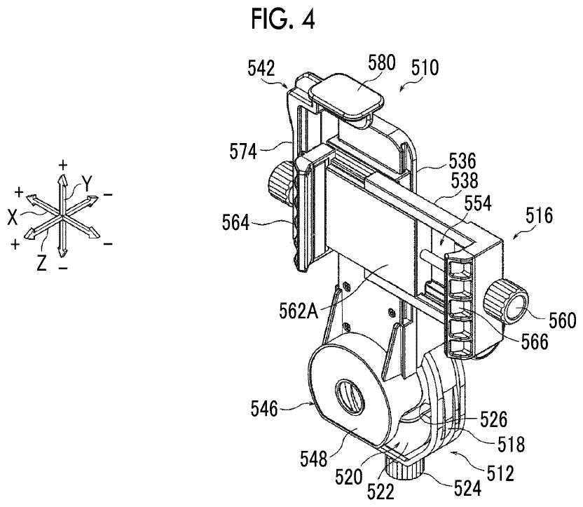

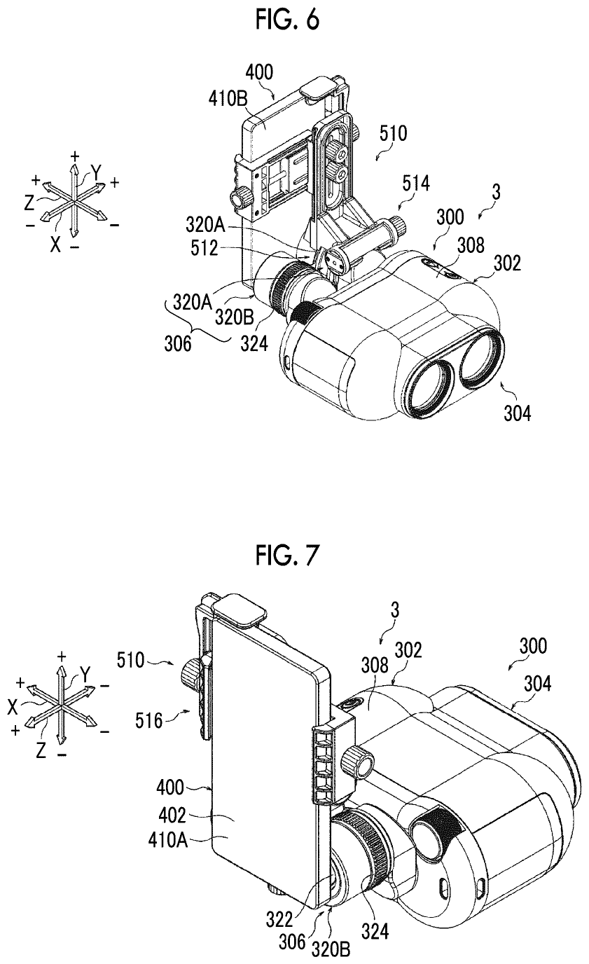

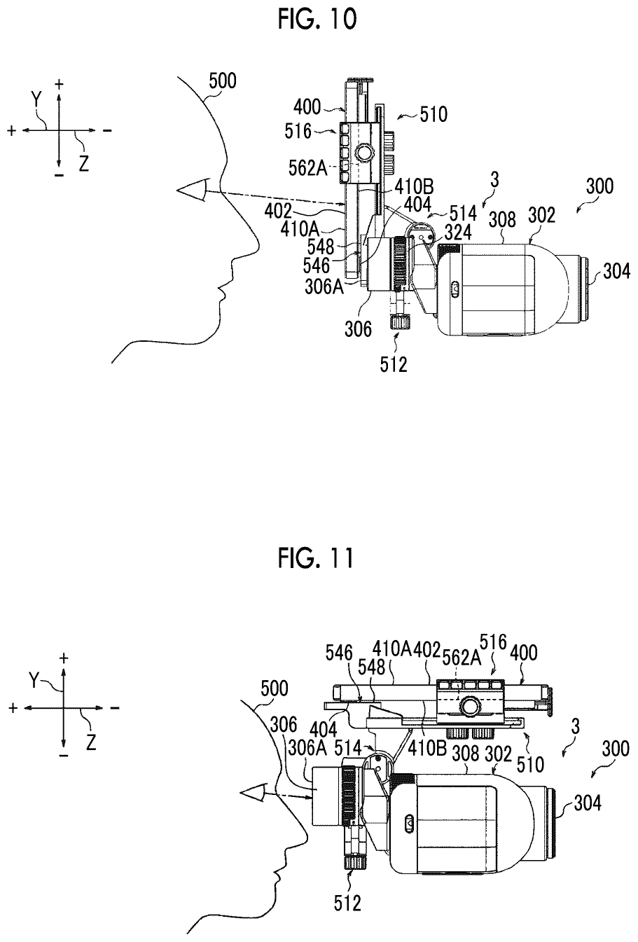

As an example, FIGS. 6 and 7 show a state in which the smartphone 400 is held by the holding portion 516, the adapter 510 is fixed to the binocle 300, and the holding portion 516 is rotated to the first position. Hereinafter, a usage form of the imaging system 3 shown in FIGS. 6 and 7 as an example will be referred to as a first observation mode. In the first observation mode, the holding surface 562A (see FIG. 4) is positioned on the Z+ side with respect to the rear end surface 306A (see FIGS. 10 and 11) of the ocular optical portion 306, and the rear surface 410B of the smartphone 400 faces the rear end surface 306A of the ocular optical portion 306 in the Z direction.

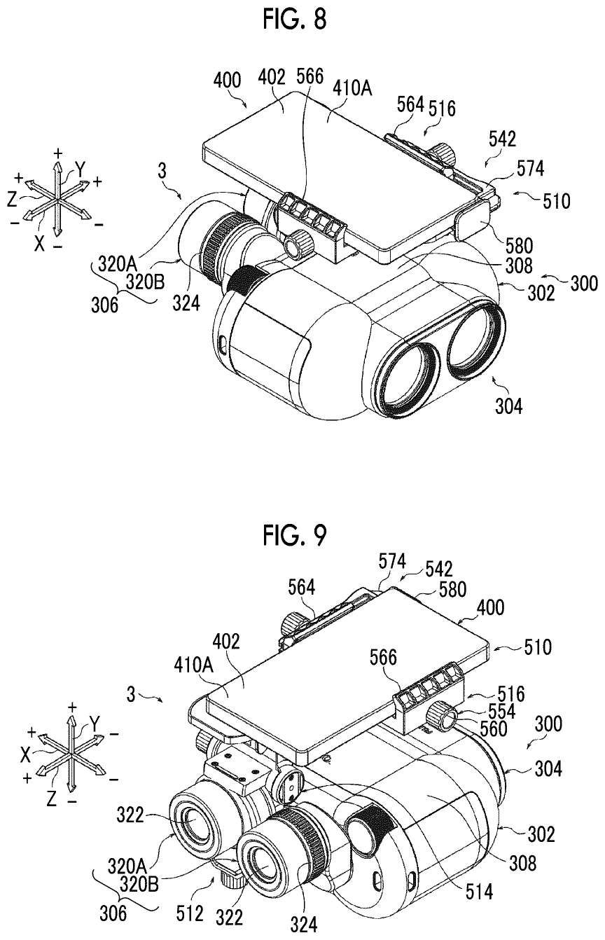

As an example, FIGS. 8 and 9 show a state in which the smartphone 400 is held by the holding portion 516, the adapter 510 is fixed to the binocle 300, and the holding portion 516 is rotated to the second position. Hereinafter, a usage form of the imaging system 3 shown in FIGS. 8 and 9 as an example will be referred to as a second observation mode. In the second observation mode, the entire holding portion 516 including the holding surface 562A (refer to FIG. 4) is positioned on the Z− side (that is, the objective optical portion 304 side) with respect to the rear end surface 306A (refer to FIGS. 10 and 11) of the ocular optical portion 306.

The holding portion 516 is rotated to the second position in a state where the smartphone 400 is held by the holding portion 516, but the holding portion 516 may be rotated to the second position in a state where the smartphone 400 is removed from the holding portion 516, or the smartphone 400 may be removed from the holding portion 516 in a state where the holding portion 516 is rotated to the second position.

Next, an action of the imaging system 3 will be described.

First, a fixing method for fixing the adapter 510 to the binocle 300 will be described. The fixed portion 512 is fixed to the lens barrel 324 of the eyepiece lens portion 320A disposed on the X+ side between the eyepiece lens portion 320A and the eyepiece lens portion 320B provided in the binocle 300. Specifically, the eyepiece lens portion 320A is inserted into a fixing hole 526 (see FIGS. 3 and 4) formed inside the fixing member 518 (see FIGS. 3 to 5), and the position of the fastening member 522 (see FIGS. 3 and 4) is adjusted by the fastening screw 524 (see FIGS. 3 and 4) of the fastening mechanism 520 (see FIGS. 3 and 4), so that the size of the fixing hole 526 is adjusted. Accordingly, the fastening member 522 and the fixing member 518 are fixed to the lens barrel 324 of the eyepiece lens portion 320A in a tightened state.

Next, a holding method of holding the smartphone 400 in the holding portion 516 will be described. First, in a state where a tightened state of a locking screw 560 (see FIGS. 3 and 4) provided in the width adjustment mechanism 554 (see FIGS. 3 and 4) is released, the width between the first holding portion 564 (see FIGS. 3 and 4) and the second holding portion 566 (see FIGS. 3 and 4) is widened. Subsequently, the smartphone 400 is inserted between the first holding portion 564 and the second holding portion 566 in a vertical posture. Subsequently, the widths of the first holding portion 564 and the second holding portion 566 are adjusted to a width at which the smartphone 400 is sandwiched by the first holding portion 564 and the second holding portion 566. Then, the locking screw 560 is brought into a tightened state. Accordingly, the smartphone 400 is held by the first holding portion 564 and the second holding portion 566.

In addition, the position restriction portion 580 (see FIGS. 3 and 4) comes into contact with the smartphone 400 by adjusting the position of the position restricting member 574 (see FIGS. 3 and 4) in a state in which a tightened state of the locking screw 568 (see FIG. 3) provided in the position restriction mechanism 542 (see FIGS. 3 and 4) is released. Then, the locking screw 560 is brought into a tightened state. As a result, the position of the smartphone 400 in the vertical direction is restricted by the position restriction portion 580. The smartphone 400 may be held by the holding portion 516 in a state in which the holding portion 516 is rotated to the first position, or may be held by the holding portion 516 in a state in which the holding portion 516 is rotated to the second position. The position of the smartphone 400 is stored by the position restriction portion 580, and the smartphone 400 can be attached to the same position again after the smartphone 400 is detached.

Next, a method of using the imaging system 3 in a case where the imaging system 3 is in the first observation mode will be described. In the first observation mode, the holding portion 516 is rotated to the first position. In a state where the holding portion 516 is rotated to the first position, a first restriction portion 0548 (see FIGS. 3 and 4) of a light restriction portion 546 (see FIGS. 3 and 4) comes into contact with a rear end surface of the eyepiece lens portion 320A from the Z+ side. In a state in which the holding portion 516 is rotated to the first position, the locking screw 534 (see FIG. 3) provided in the locking mechanism 532 (see FIG. 3) is brought into a tightened state, so that the rotation of the rotating portion 530 (see FIGS. 3 and 5) is restricted with respect to the rotation support portion 528 (see FIGS. 3 and 5). In a state in which the holding portion 516 is rotated to the first position and the smartphone 400 is held by the holding portion 516, the eyepiece lens 322 of the eyepiece lens portion 320A positioned on the X+ side of the pair of eyepiece lens portions (eyepiece lens portions 320A and 320B) faces the camera 404.

Here, in a case where the position of the camera 404 is shifted with respect to the eyepiece lens 322 of the eyepiece lens portion 320A, the position of the smartphone 400 is adjusted by the position adjustment mechanism 540 (see FIG. 3). Specifically, in a state where a tightened state of the locking screw 560 provided in the width adjustment mechanism 554 is released, the second holding member 538 (see FIGS. 3 and 4) slides in at least one direction of the X direction or the Y direction with respect to the first holding member 536 (see FIGS. 3 and 4), and thus the position of the smartphone 400 is adjusted to a position where the camera 404 faces the eyepiece lens 322. Then, the locking screw 560 is brought into a tightened state. As a result, the positions of the smartphone 400 in the X direction and the Y direction are fixed.

In a state in which the camera 404 of the smartphone 400 faces the eyepiece lens 322, light that has passed through the eyepiece lens 322 is incident on the camera 404. Then, the subject is imaged by the camera 404 via the binocle 300, and the image obtained by imaging the subject is displayed on the touch panel display 402. Therefore, as shown in FIG. 10 as an example, the user 500 can check the enlarged image on the touch panel display 402 as compared with a case where the subject is directly imaged with the smartphone 400.

Next, a method of using the imaging system 3 in a case where the imaging system 3 is in the second observation mode will be described. In a case where a tightened state of the locking screw 534 (see FIG. 3) provided in the locking mechanism 532 (see FIG. 3) is released, a state where the rotation of the rotating portion 530 (see FIGS. 3 and 5) is allowed with respect to the rotation support portion 528 (see FIGS. 3 and 5) is obtained. Then, the holding portion 516 is in a state of being rotated from the first position to the second position. The holding portion 516 may be rotated from the first position to the second position in a state in which the smartphone 400 is held by the holding portion 516, or may be rotated from the first position to the second position in a state in which the smartphone 400 is detached from the holding portion 516.

In a state in which the holding portion 516 is rotated to the second position, the locking screw 534 provided in the locking mechanism 532 is brought into a tightened state, so that the rotation of the rotating portion 530 is restricted with respect to the rotation support portion 528. In a state in which the holding portion 516 is rotated to the second position, the entire holding portion 516 including the holding surface 562A is positioned on the Z− side (that is, the objective optical portion 304 side) with respect to the rear end surface 306A of the ocular optical portion 306. Therefore, as shown in FIG. 11 as an example, in the second observation mode, the protrusion of the holding portion 516 to the Z+ side is suppressed as compared with the first observation mode. Therefore, the user 500 can directly look through the ocular optical portion 306.

As shown in FIGS. 1 to 11, the smartphone 400 can be attached to the binocle 300 via the adapter 510. Accordingly, the smartphone 400 can be easily attached to the adapter 510. In the above-described embodiment, the adapter 510 is a member independent of the binocle 300, but the binocle 300 may be a model comprising a mechanism corresponding to the adapter 510.

In addition, as shown in FIGS. 1 to 11, the adapter 510 has a mechanism that is capable of switching between a first state in which the smartphone 400 attached to the binocle 300 can perform imaging via the binocle 300 and a second state different from the first state. The first state corresponds to a “first observation mode” in FIGS. 1 to 11, and the second state corresponds to a “second observation mode” in FIGS. 1 to 11. Accordingly, it is possible to perform imaging via the binocle 300 and observation through the binocle 300 with the naked eye while the smartphone 400 is attached to the binocle 300. In the embodiments of FIGS. 1 to 11, the optical device is an example of a binocle, but the optical device may be a telescope (monocular).

Next, the connection between the smartphone 400 and the external network will be described. As an example, FIG. 12 shows a cloud image management system including a smartphone 400. The smartphone 400 is connected to the image management server 5 via a network such as the Internet. The image management server 5 may be a physical server or a virtual server (so-called cloud server).

As described above, the smartphone 400 can not only directly image the subject by the camera 404 but also image the subject through the binocle 300 (first state). The smartphone 400 transmits image data obtained by imaging to the image management server 5 via a network, and the image management server 5 stores and manages the image data.

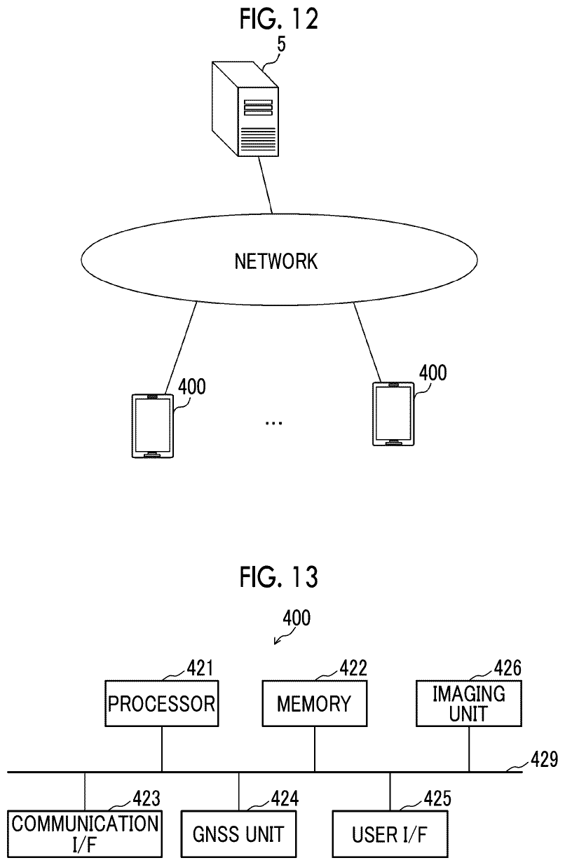

Next, a configuration of the smartphone 400 will be described. FIG. 13 is a diagram showing an example of a hardware configuration of the smartphone 400. The smartphone 400 comprises a processor 421, a memory 422, a communication I/F 423, a global navigation satellite system (GNSS) unit 424, a user I/F 425, and an imaging unit 426. The processor 421, the memory 422, the communication I/F 423, the GNSS unit 424, the user I/F 425, and the imaging unit 426 are connected to each other through, for example, a bus 429.

The processor 421 is a circuit that performs signal processing, and is, for example, a CPU that performs control of the entire smartphone 400. The processor 421 may be implemented by another digital circuit, such as an FPGA or a DSP. In addition, the processor 421 may be implemented by combining a plurality of digital circuits with each other.

For example, the memory 422 includes a main memory and an auxiliary memory. The main memory is, for example, a RAM. The main memory is used as a work area of the processor 421. The auxiliary memory is, for example, a non-volatile memory such as a magnetic disk, an optical disk, or a flash memory. The auxiliary memory stores various programs for operating the smartphone 400. The programs stored in the auxiliary memory are loaded into the main memory and executed by the processor 421.

In addition, the auxiliary memory may include a portable memory that can be detached from the smartphone 400. Examples of the portable memory include a memory card such as a universal serial bus (USB) flash drive or a secure digital (SD) memory card, and an external hard disk drive.

The communication I/F 423 is a communication interface that performs wireless communication with the outside of the smartphone 400. For example, the communication I/F 423 indirectly performs communication with the image management server 5 by being connected to the Internet via the moving object communication network. The communication I/F 423 is controlled by the processor 421.

The GNSS unit 424 is, for example, a satellite positioning system such as a global positioning system (GPS), and acquires positional information (longitude and latitude) of the smartphone 400. The GNSS unit 424 is controlled by the processor 421.

The user I/F 425 includes, for example, an input device that receives an operation input from the user, and an output device that outputs information to the user. The input device can be implemented by, for example, a key (for example, a keyboard) or a remote controller. The output device can be implemented by, for example, a display or a speaker. In addition, the input device and the output device may be implemented by a touch panel or the like. The user I/F 425 is controlled by the processor 421.

The imaging unit 426 is a portion having a function of imaging an imaging target, and includes a camera 404. The imaging unit 426 is controlled by the processor 421.

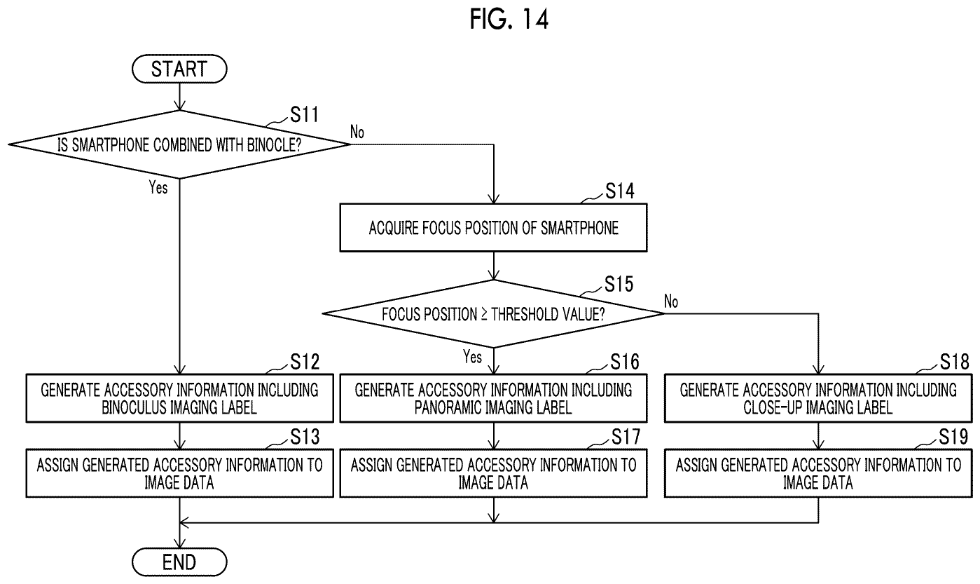

Next, an accessory information generation method executed by the smartphone 400 will be described. FIG. 14 is a flowchart showing a procedure of processing of executing an accessory information generation method of assigning accessory information to image data captured by a smartphone 400, that is, imaging data. In particular, the processor 421 of the smartphone 400 mainly executes the main processing.

First, the processor 421 determines whether or not the smartphone 400 itself is combined with the binocle 300 (step S11). In other words, the processor 421 discriminates whether or not the imaging by the smartphone 400 is performed via the binocle 300. The processor 421 can perform the discrimination based on, for example, the following information. The imaging data is stored in, for example, the memory 422.
Image analysis of imaging data captured by imaging unit 426
Posture of smartphone 400 by posture sensor (not shown) provided in smartphone 400
Focus information (imaging distance) of smartphone 400
Detection result by proximity sensor (not shown) provided in smartphone 400

In a case where the smartphone 400 and the binocle 300 are combined (step S11: Yes), the processor 421 generates the accessory information including a binoculus imaging label (step S12). The binoculus imaging label is a label indicating that the imaging pickup is imaging via the binocle 300. Further, the processor 421 assigns the generated accessory information to the imaging data (step S12).

On the other hand, in a case where the smartphone 400 and the binocle 300 are not combined (step S11: No), the processor 421 acquires the focus position of the smartphone 400 (step S14). The focus position is an imaging distance to the subject. In a case where the focus position is equal to or greater than the predetermined threshold value (focus position≥threshold value) (step S15: Yes), the processor 421 assigns the accessory information including a panoramic imaging label to the imaging data (step S16). The panoramic imaging label is a label indicating that the imaging is not performed via the binocle 300 and is imaging in which the entire subject is captured from a long distance. Further, the processor 421 assigns the generated accessory information to the imaging data (step S17).

In addition, in a case where the focus position is not equal to or greater than the predetermined threshold value (focus position<threshold value) (step S15: No), the processor 421 assigns the accessory information including the close-up imaging label to the imaging data (step S18). The close-up imaging label is a label indicating that the imaging is not performed via the binocle 300, but is imaging in which the subject is captured from a short distance. Further, the processor 421 assigns the generated accessory information to the imaging data (step S19).

In the case of the static image capturing, the smartphone 400 executes the main processing immediately after the imaging, for example. In the case of the video capturing, the smartphone 400 may execute the main processing for each frame capturing or may execute the main processing after the video capturing is ended.

In any case, the accessory information includes at least the positional information and the azimuthal angle information of the imaging. The positional information is acquired from, for example, the GNSS unit 424 and is stored in the memory 422 together with the imaging data. The azimuthal angle information is acquired from, for example, an electronic compass (not shown) mounted on the smartphone 400 and is stored in the memory 422 together with the imaging data. The accessory information may further include angle-of-view information. The angle-of-view information is acquired from, for example, the imaging unit 426 and is stored in the memory 422 together with the imaging data.

The accessory information generation method according to the processing of FIG. 14 includes a first generation step of generating accessory information including at least whether or not imaging is performed through the binocle 300, by the smartphone 400 that is attachable to the binocle 300 and that has imaged image data. Accordingly, it is possible to appropriately determine whether or not the image data obtained by the imaging system 3 is obtained through the binocle 300. Accordingly, it is easy to manage the image data obtained by the imaging system 3.

The first generation step includes a step (step S11) of discriminating whether or not the imaging is performed by the smartphone 400 via the binocle 300, and a step (steps S12, S16, and S18) of generating the accessory information including whether or not the imaging is performed via the binocle 300 based on a result of the discrimination. As a result, the processor 421 that performs overall control of the smartphone 400 can perform the first generation step.

The above-described discrimination can be performed based on, for example, image analysis of image data, an imaging distance in imaging, or a detection result by a proximity sensor provided in the smartphone 400. Accordingly, the processor 421 can discriminate whether or not the imaging is performed via the binocle 300.

In addition, the accessory information in a case where the imaging is performed without the binocle 300 (after step S14) includes information indicating whether or not the imaging is close-up imaging based on an imaging distance (for example, a focus position) in the imaging. Specifically, the accessory information generated in step S16 includes information (a panoramic imaging label) indicating that the imaging is not the close-up imaging, and the accessory information generated in step S18 includes information (a close-up imaging label) indicating that the imaging is the close-up imaging. Accordingly, it is possible to appropriately determine the relevance of the image data obtained by imaging in a state in which the smartphone 400 is not attached to the binocle 300 to other image data in consideration of whether or not the imaging is close-up imaging.

Further, the accessory information generation method according to the processing of FIG. 14 includes an assignment step of assigning the generated accessory information to the image data (steps S13, S17, and S19). It is possible to appropriately determine whether or not the image data obtained by the imaging system 3 is obtained through the binocle 300. Accordingly, it is easy to manage the image data obtained by the imaging system 3.

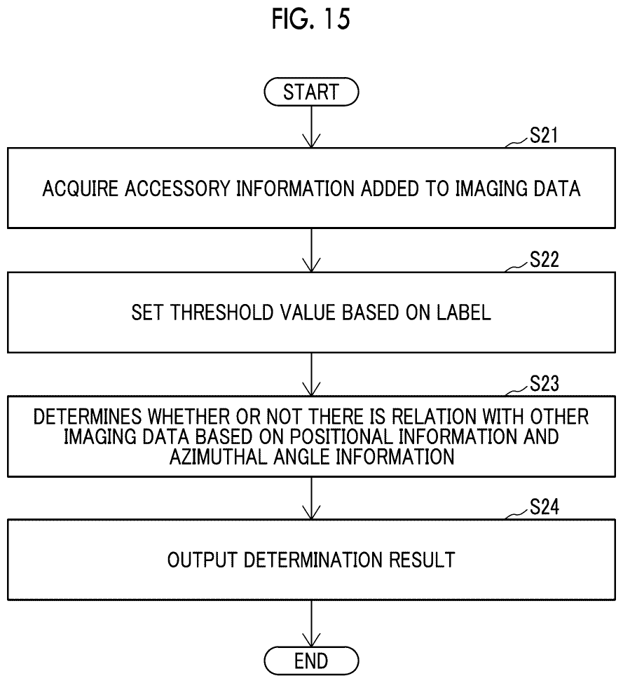

FIG. 15 is a flowchart showing a procedure of processing of determining a relevance between a plurality of pieces of imaging data, which is included in the accessory information generation method. The basic assumption is that the image management server 5 executes the processing for each piece of imaging data received from one or more smartphones 400. As a modification example, the smartphone 400 may execute the processing for each imaging data (imaging data received from another electronic apparatus may be added) stored in the smartphone 400.

First, the image management server 5 acquires the accessory information added to the imaging data received from the smartphone 400 (step S21). Next, the image management server 5 sets the threshold value based on the label (any of the binoculus imaging label, the panoramic imaging label, or the close-up imaging label) included in the accessory information (step S22).

Further, the image management server 5 determines whether or not there is a relation with other imaging data based on the positional information and the azimuthal angle information included in the accessory information and the set threshold value (step S23). In step S23, angle-of-view information that may be included in the accessory information may be further used. In this case, for example, an angle of view wider than the angle of view indicated by the angle-of-view information may be used in consideration of an error of the azimuthal angle information.

Finally, the image management server 5 outputs the determination result (step S24). The output is transmitted from the image management server 5 to the smartphone 400 via the network, for example. In a case where the smartphone 400 executes the main processing, the touch panel display 402 outputs the determination result.

The processing of FIG. 15 corresponds to a second generation step of generating the related information between the image data based on the accessory information for the plurality of pieces of image data including the image data to which the accessory information is assigned in the assignment step after the first generation step and the assignment step in FIG. 14. Accordingly, it is possible to appropriately determine the relevance to the other image data in consideration of whether or not the imaging is performed via the binocle 300. It should be noted that a processor (not shown) of the image management server 5 may execute the second generation step, or a processor 421 of the smartphone 400 may execute the second generation step.

In addition, it can be assumed that the accessory information includes first label information indicating whether or not the imaging is performed via the binocle 300, in addition to the positional information of the imaging and the azimuthal angle information of the imaging. The first label information is any one of the above-mentioned binoculus imaging label, the panoramic imaging label, or the close-up imaging label. In the second generation step, the image management server 5 may calculate a region of the imaging based on at least the positional information and the azimuthal angle information, and may generate the related information between the image data based on the region of the imaging.

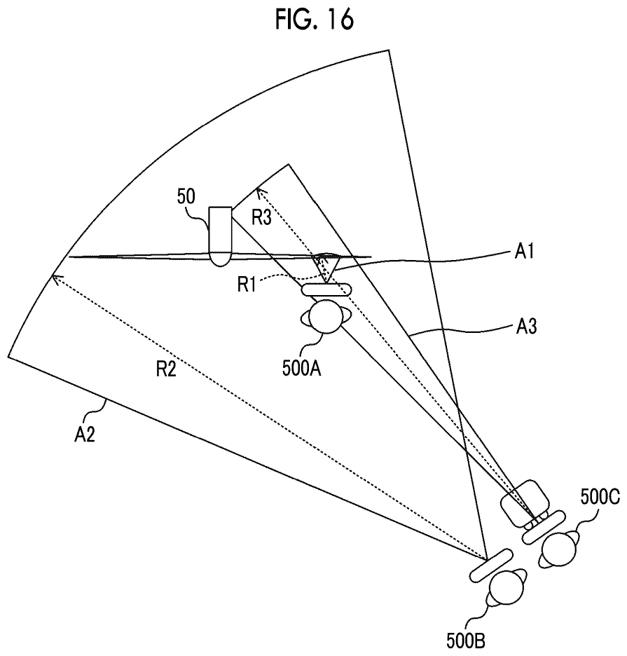

A region of the imaging will be described. FIG. 16 is a conceptual diagram showing states of various types of imaging. In the present example, the user 500A, the user 500B, and the user 500C attempt to image the windmill 50, which is an example of the subject, from different positions.

The user 500A is located in the vicinity of the windmill 50 and images the windmill 50 only with the smartphone 400 without using the binocle 300. That is, the main imaging is performed under the imaging distance R1 in which the imaging distance with respect to the windmill 50 is short, and the imaging region is the imaging region A1 in which the imaging region is narrow (so-called close-up imaging). The imaging data is assigned accessory information including a close-up imaging label as first label information.

The user 500B is positioned at a predetermined distance from the windmill 50 and images the windmill 50 only with the smartphone 400 without using the binocle 300. That is, the main imaging is performed under the imaging distance R2 in which the imaging distance with respect to the windmill 50 is long, and the imaging region is the imaging region A2 in which the imaging region is wide (so-called panoramic imaging). The imaging data is assigned accessory information including a panoramic imaging label as the first label information.

The user 500C is positioned at a predetermined distance from the windmill 50 and images the windmill 50 with the smartphone 400 through the binocle 300. That is, the main imaging is performed under the imaging distance R3 in which the imaging distance with respect to the windmill 50 is large, and the imaging region is the imaging region A3 in which the imaging region is limited to the visual field of the binocle 300 (so-called telephoto imaging). The imaging data is assigned the accessory information including the binoculus imaging label as the first label information, and corresponds to the first state described above.

The image management server 5 acquires the imaging data and the accessory information from the smartphone 400 of each user via the network. The accessory information includes at least the positional information and the azimuthal angle information. The positional information can be acquired from, for example, a GNSS unit 424 of the smartphone 400, and the azimuthal angle information can be acquired from, for example, an electronic compass (not shown) mounted on the smartphone 400. The image management server 5 can calculate the imaging regions A1, A2, and A3 based on the acquired positional information and azimuthal angle information.

As a result, the image management server 5 may generate the related information between the image data based on the region of the imaging. For example, since all of the three imaging regions A1, A2, and A3 include the windmill 50 that is the same subject, the image management server 5 can determine that the three pieces of image data are related to each other. Accordingly, it is possible to appropriately determine the image data obtained by imaging the same subject.

In addition, it can be assumed that the accessory information in a case where the imaging is performed without the binocle 300 includes second label information indicating whether or not the imaging is close-up imaging, based on an imaging distance in the imaging. The second label information is any of the panoramic imaging label or the close-up imaging label described above. Then, in the second generation step, the image management server 5 can calculate the region of the imaging based on at least the first label information, the positional information, the azimuthal angle information, and the second label information.

That is, the image management server 5 can set the threshold value of the distance based on the first label information and the second label information. Accordingly, it is possible to appropriately determine the relevance of the image data obtained by imaging in a state in which the smartphone 400 is not attached to the binocle 300 to other image data in consideration of whether or not the imaging is close-up imaging.

In the second generation step, the image management server 5 may generate the related information between the image data based on a category of the subject of the imaging instead of generating the related information based on the positional information or the like as in the example of FIG. 15. For example, a threshold value (R1 to R3 in the example of FIG. 16) may be set based on a category such as a “windmill” set in advance, and the related information may be generated based on the threshold value. As a result, the relevance between the image data can be more appropriately determined.

In addition, the related information between the image data may be information for determining image data obtained by imaging the same subject among the plurality of pieces of image data. In the example of FIG. 16, since the three imaging regions A1, A2, and A3 include the windmill 50 which is the same subject, it is determined that the image data of each of the imaging regions A1, A2, and A3 is obtained by imaging the same subject. Here, it is desirable that the related information between the image data includes information for associating the image data obtained by imaging the same subject with the same subject. As a result, it is possible to associate not only the imaging data but also the inspection target subject.

Each of the embodiments and the modification examples described above can be implemented in combination with each other.

The accessory information generation method described in the above embodiment can be implemented by executing the accessory information generation program prepared in advance on a computer. This accessory information generation program is recorded in a computer-readable storage medium and is executed by being read from the storage medium by a computer. In addition, this accessory information generation program may be provided in a form of being stored in a non-transitory storage medium, such as a flash memory, or may be provided via a network, such as the Internet. The computer that executes this accessory information generation program may be included in an accessory information generation apparatus, may be included in an electronic apparatus such as a smartphone, a tablet terminal, or a personal computer capable of communicating with the accessory information generation apparatus, or may be included in a server apparatus capable of communicating with the accessory information generation apparatus and the electronic apparatus.

Although various embodiments have been described above, it goes without saying that the present invention is not limited to these examples. It is apparent that those skilled in the art may perceive various modification examples or correction examples within the scope disclosed in the claims, and those examples are also understood as falling within the technical scope of the present invention. In addition, each constituent in the embodiment may be used in any combination without departing from the gist of the invention.

The present application is based on Japanese Patent Application (JP2022-208410A) filed on Dec. 26, 2022, the content of which is incorporated in the present application by reference.

### EXPLANATION OF REFERENCES

3: imaging system
5: image management server
50: windmill
300: binocle
302: main body
304: objective optical portion
306: ocular optical portion
306A: rear end surface
308: housing
320A, 320B: eyepiece lens portion
322: eyepiece lens
324: lens barrel
400: smartphone
402: touch panel display
404: camera
410A: front surface
410B: rear surface
421: processor
422: memory
423: communication I/F
424: GNSS unit
425: user I/F
426: imaging unit
429: bus
500, 500A, 500B, 500C: user
510: adapter
512: fixed portion
514: support portion
516: holding portion
518: fixing member
520: fastening mechanism
522: fastening member
524: fastening screw
526: fixing hole
528: rotation support portion
530: rotating portion
532: locking mechanism
534, 560, 568: locking screw
536: first holding member
538: second holding member
540: position adjustment mechanism
542: position restriction mechanism
546: light restriction portion
548: first restriction portion
554: width adjustment mechanism
562A: holding surface
564: first holding portion
566: second holding portion
574: position restricting member
580: position restriction portion
584: stopper portion
R1 to R3: imaging distance
A1 to A3: imaging region

What is claimed is:

1. An accessory information generation method in an imaging apparatus that is attachable to an optical device, the accessory information generation method comprising:
first generating accessory information including at least whether or not imaging is performed via the optical device in image data captured by the imaging apparatus.

2. The accessory information generation method according to claim 1,
wherein the imaging apparatus is attachable to the optical device via an adapter.

3. The accessory information generation method according to claim 2,
wherein the adapter has a mechanism capable of switching the imaging apparatus attached to the optical device between a first state in which imaging via the optical device is possible and a second state different from the first state.

4. The accessory information generation method according to claim 1,
wherein the first generating includes
discriminating whether or not the imaging is performed via the optical device, and
generating accessory information including whether or not the imaging is performed via the optical device based on a result of the discrimination.

5. The accessory information generation method according to claim 4,
wherein the discrimination is performed based on image analysis of the image data.

6. The accessory information generation method according to claim 4,
wherein the discrimination is performed based on an imaging distance in the imaging.

7. The accessory information generation method according to claim 4,
wherein the discrimination is performed based on a detection result of a proximity sensor provided in the imaging apparatus.

8. The accessory information generation method according to claim 1,
wherein the accessory information in a case where the imaging is performed without the optical device includes information indicating, based on an imaging distance in the imaging, whether or not the imaging is close-up imaging.

9. The accessory information generation method according to claim 1, further comprising:
assigning the accessory information to the image data.

10. The accessory information generation method according to claim 9, further comprising:
second generating, for a plurality of pieces of image data including image data to which the accessory information is assigned by the assigning, related information between the plurality of pieces of image data, based on the accessory information.

11. The accessory information generation method according to claim 10,
wherein the accessory information includes first label information indicating whether or not the imaging is performed via the optical device, positional information of the imaging, and azimuthal angle information of the imaging, and
the second generating comprises calculating a region of the imaging based on at least the positional information and the azimuthal angle information, and generating the related information between the image data based on the region of the imaging.

12. The accessory information generation method according to claim 11,
wherein the accessory information in a case where the imaging is performed without the optical device includes second label information indicating, based on an imaging distance in the imaging, whether or not the imaging is close-up imaging, and
the second generating comprises calculating a region of the imaging based on at least the first label information, the positional information, the azimuthal angle information, and the second label information.

13. The accessory information generation method according to claim 10,
wherein the second generating comprises generating the related information between the image data based on a category of a subject of the imaging.

14. The accessory information generation method according to claim 10,
wherein the related information between the image data is information capable of determining image data obtained by imaging the same subject among the plurality of pieces of image data.

15. The accessory information generation method according to claim 14,
wherein the related information between the image data includes information for associating the image data obtained by imaging the same subject with the same subject.

16. The accessory information generation method according to claim 1,
wherein the optical device is a binocle or a telescope.

17. An imaging system comprising:
an optical device; and
an imaging apparatus that includes a processor and is attachable to the optical device,
wherein the processor is configured to generate accessory information including at least whether or not imaging is performed via the optical device in image data captured by the imaging apparatus.

18. A non-transitory computer-readable storage medium storing a program of an imaging system including an optical device, and an imaging apparatus that includes a processor and is attachable to the optical device, the program causing the processor of the imaging apparatus to execute processing of:
generating accessory information including at least whether or not imaging is performed via the optical device in image data captured by the imaging apparatus.
